(19) United States
(12) Patent Application Publication
(10) Pub. No.: US 2021/0126572 A1
(43) Pub. Date: Apr. 29, 2021

(54) LIGHT TRACKING ASSEMBLY FOR SOLAR AND WIND POWER ENERGY

(71) Applicant: BEAM GLOBAL, San Diego, CA (US)

(72) Inventor: Desmond Wheatley, Rancho Santa Fe, CA (US)

(21) Appl. No.: 16/665,851

(22) Filed: Oct. 28, 2019

(51) Int. Cl. H02S 10/12; H02S 20/32; H02S 40/38; F03D 9/00

(52) U.S. Cl. CPC H02S 10/12; F03D 9/007; H02S 40/38; H02S 20/32

(57) ABSTRACT

An apparatus and method for collecting renewable energy includes a solar panel and a wind turbine that are mounted on a same extension arm, In this combination, as the extension arm is rotated on a support pole, the solar panel is simultaneously rotated through a directional arc θ and an inclination arc Φ in accordance with a predetermined daily schedule that is based on the time of day and the latitude of the apparatus. Also, as the solar panel is moved, the wind turbine is free to follow wind direction and maximize its collection of wind energy. To further maximize the energy collection capability of the apparatus, the wind turbine is located on the extension arm to remain down-sun from the solar panel and to remain free from wind flow interference that may be caused by the solar panel.

### FIELD OF THE INVENTION

The present invention pertains generally to an apparatus, systems and methods which collect electric energy for commercial use from sources, such as solar arrays, wind turbines, and the public grid, In particular, the present invention pertains to an apparatus that includes, in combination, a solar panel and a wind turbine that operate collectively without interfering with each other and their respective operations. The present invention is particularly, but not exclusively, useful as an apparatus for collecting renewable energy from different sources, with different energy collecting capabilities, to thereby further optimize a combined renewable and publicly available energy collecting capability.

### BACKGROUND OF THE INVENTION

There are many circumstances wherein it is desirable to have a source of electricity that may not other wise be available. Indeed, this may be the case for any of several different reasons. When renewable energy sources are to be used, factors such as location, climatic conditions, accessibility arid costs, are important considerations for determining how best to provide for the source of electricity.

In recent years, the availability of renewable energy sources has provided a great deal of flexibility for determining how to extend the availability of electrical sources. For example, wind energy and solar energy systems can be more localized and more mobile than other sources of electrical energy, Accordingly, these sources of renewable energy are being effectively commercially exploited.

With specific focus on solar energy and wind energy as sources of renewable energy, it is clear that the devices which rely on these different meteorological phenomena are structurally different and they have different capabilities. Importantly, although these phenomena are mutually exclusive for the respective operations, their outputs are cumulative. The consequence here is that when employed together, each energy source can operate independently and the combined effect of the different devices (i.e. wind and solar) can continue to generate electric power over an extended daily duty cycle. Thus, as a practical matter, it may be desirable to integrate these devices for their deployment. Further, it may be desirable to integrate the combination of wind and solar devices with the public grid, if available.

In order to optimize an integrated wind/solar electricity generator it is necessary that the respective operational capabilities of the generators be compatible with each other. Specifically, their respective operations should not interfere with the natural phenomenon that is the source of the other's operation. For instance, the solar generator (e.g. a solar panel) must never be in the shade of the wind generator. Stated differently, the wind generator must remain “down-sun” from the solar generator. On the other hand, the wind generator must be located sufficiently “down-wind” from the solar generator so that the solar generator will riot operationally interfere with the wind generator,

In light of the above it is an object of the present invention to provide an integrated system which employs the combination of a wind generator with a solar generator for the generation of electricity. Another object of the present invention is to provide an integrated system for collecting solar energy and wind energy that allows the solar energy component (e,g. a solar panel) to be continuously oriented relative to the path of the sun. Still another object of the present invention is to provide an integrated system wherein a solar energy component and a wind energy component are mounted together as a same structural assembly for independent, non-interfering operations. Another object of the present invention is to provide an integrated wind/solar electricity generator which can be connected with the public grid for a combined use of the different sources of energy. Yet another object of the present invention is to provide an integrated solar/wind energy generator system that is simple to use, easy to manufacture and comparatively cost effective.

### SUMMARY OF: THE INVENTION

The present invention is a renewable energy system that employs devices which, in combination, generate electricity from both solar energy and wind energy. As an integrated system, the present invention is created as a compact unit that can either be permanently installed at a specific location, be connected to operate with a public grid, or be constructed as a mobile unit that can be periodically repositioned as desired or required. For either embodiment, (permanent or mobile) it is an important feature of the present invention that the solar component and the wind component be independently operable. Further, it is important that these components not interfere with each other's operation.

Structurally, the system (i.e. apparatus) for collecting and storing renewable energy in accordance with the present invention includes a support pole that defines a pole axis. An extension arm is mounted horizontally on the support pole, perpendicular to the pole axis of the support pole. Also, the extension arm is mounted for rotation on the support pole around the pole axis in a plane perpendicular to the pole axis.

A solar panel is mounted at one end of the extension arm for collecting solar energy. Preferably, the solar panel will have a plurality of photovoltaic cells that are mounted in an array on the solar panel. And it will be inclined at a variable angle Φ relative to the pole axis. More specifically, the solar panel is mounted on the extension arm for rotation to a predetermined angle Φ around a horizontal axis that is perpendicular to the extension arm and perpendicular to the pole axis. Additionally, a wind turbine is mounted at the other end on the extension arm for collecting wind energy. As so mounted, the wind turbine is free to rotate through an angle Ψ about an axis parallel to the pole axis,

The apparatus also includes a motor for rotating the extension arm through an azimuthal angle θ, and for rotating the solar panel through the predetermined angle Φ. Both of these rotations are accomplished simultaneously in accordance with a predetermined schedule. Specifically, the import here is to maintain the solar panel oriented during a day for optimal absorption of sour energy. Within the combination of components mentioned above, the present invention includes a storage battery that is connected to both the solar panel and to the wind turbine to store the collected energy,

For an assembly of the system of the present invention it is to be appreciated that the solar panel has a weight Wₛ and the wind turbine has a weight W_{w}. With this in mind, the extension arm will have a balance point between its first and second ends, where the weight of the wind turbine W_{w}, acting on the extension arm at a distance d_{w} from the balance point, and with the weight of the solar panel Wₛ, acting on the extension arm at a distance dₛ from the balance point will counterbalance each other (W_{w}d_{w}=Wₛdₛ). Also, with a view toward preventing operational interference between the wind turbine and the solar panel, the wind turbine is preferably located at a vertical height h_{w} above the extension arm. In particular, the height h_{w}, and the distances d_{w} and dₛ are selected to position the wind turbine on the apparatus to avoid an interference by turbulent wind flow to the wind turbine that may be caused by the solar panel. As disclosed above, the position of the wind turbine on the extension arm is established so as to be down-sun, and out of the shade, from the solar panel.

Operationally, it is envisioned that the motor for rotating the extension arm and the solar panel will be programmed with a predetermined schedule that is based on the time of day and the path of the sun during the day. Accordingly, the angle θ is in a directional arc that extends between an initial angle θᵢ and a final angle θ_{f}. Also, the angle Φ is in an inclination arc that extends between an angle Φ₁ and Φ₂. As indicated, the directional arc θᵢ:θ_{f} and the inclination arc Φ₁:Φ₂ are established daily in accordance with the predetermined schedule.

In detail, for the predetermined schedule, θᵢ is established relative to sunrise on the day of operation, and θ_{f} is established relative to sunset on the day of operation. Also, Φ₁ is established relative to sunrise and sunset on the day of operation and Φ₂ is established relative to midday on the day of operation. Further, the directional arc and the inclination arc are established relative to the latitude of the apparatus,

As noted above, the wind/solar electricity generator of the present invention can be connected with a public grid. If this is done, the present invention envisions that a storage battery can be controlled to collect and then distribute electric energy in accordance with a prioritized protocol. Specifically, electricity taken from the public grid is used only after electricity from the wind/solar generator has been used. On the other hand, if excess energy from the wind/solar generator is available, it can be sent to the public grid to provide additional revenue.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of the apparatus of the present invention;

FIG. 2 is a graphical presentation of the directional arc θᵢ:θ_{f} envisioned for the present invention; and

FIG. 3 is a graphical presentation of the inclination arc Φ₁:Φ₂ envisioned for the present invention.

### DESCRIPTION OF THE PREFERRED EMBODIMENTS

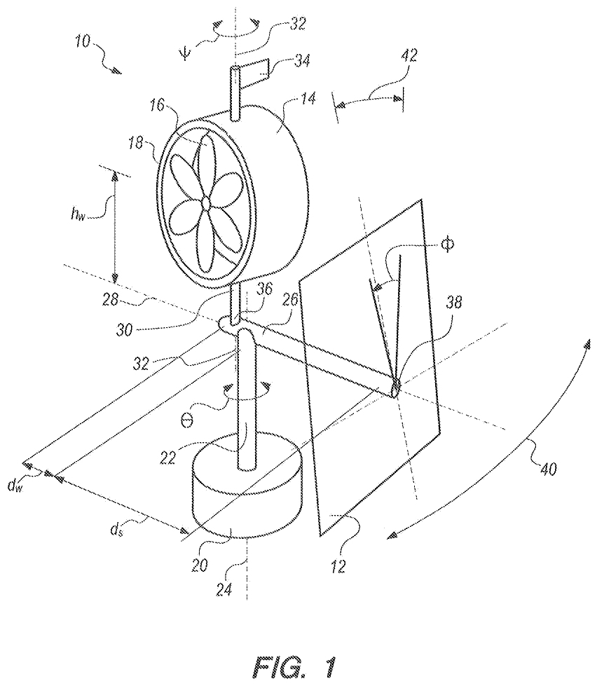

Referring initially to FIG. 1, an apparatus for collecting and storing renewable energy in accordance with the present invention is shown and is generally designated 10. As shown, the apparatus 10 includes both a solar panel 12 and a wind turbine 14. For the present invention, the solar panel 12 can he an array of photovoltaic cells that are presented in a manner well known in the pertinent art for the purpose of converting solar energy into electrical energy. The wind turbine 14 for the present invention is essentially a windmill 16 that may, or may not, be mounted in a shroud 18 For purposes of the present invention, the wind turbine 14 may be of any type well known in the pertinent art that is capable of converting wind energy into electrical energy.

Still referring to FIG. 1, it will be seen that the apparatus 10 includes a base 20 that stabilizes the apparatus 10. Mounted inside the base 20, or otherwise operationally connected with the apparatus 10, are a motor (not shown) and a storage battery (not shown). As intended for the present invention, the motor is used to reconfigure the apparatus 10 in a predetermined manner fully disclosed below. Also, the storage battery is provided to store the electrical energy generated by the solar panel 12 and/or the wind turbine 14. A portion of the electrical energy stored in the storage battery will be used to operate the apparatus 10. Excess electrical energy, however, may be used for other purposes as deemed necessary or appropriate.

Structurally, the apparatus 10 includes a support pole 22 which defines a pole axis 24. As intended for the present invention, the pole axis 24 will typically be vertically oriented. Mounted on the support pole 22 is an extension arm 26 which defines a horizontal axis 28. Further, mounted on the extension arm 26 is an elevation arm 30 that defines a vertical axis 32. In this combination, the extension arm 26 is perpendicular to the support pole 22, while the elevation arm 30 is parallel to the support pole 22 and perpendicular to the extension arm 26.

The structure for the apparatus 10 of the present invention also includes a weathervane 34 that is fixed on the shroud 18. In response to the reaction of the weathervane 34, the wind turbine 14 will be rotated around the vertical axis 32 through an angle Ψ. Depending on wind direction, the wind turbine 14 can be rotated through a 360° arc.

During an assembly of the apparatus 10 several dimensions shown in FIG. 1 are of particular importance. In particular, these dimensions include: i) h_{w}, which is the height of the e.g. of the vvindmill 16 above the horizontal axis 28: ii) d_{w}, which is the distance of the vertical axis 32 from a balance point 36 on the pole axis 24; and iii) dₛ, which is the distance between an attachment point 38 where the solar panel 12 is connected to the extension arm 26, and the balance point 36 In general, these dimensions are to be established with structural stability and operational capabilities of the apparatus 10 in mind.

For an operation of the apparatus 10, the motor (not shown) which is mounted in the support base 20 is programmed to rotate the extension arm 26 through a predetermined directional angle θ. The motor is also programmed to rotate the solar panel 12 through a predetermined inclination angle Φ. Both the rotation of the extension arm 26 and the rotation of the solar panel 12 are accomplished in accordance with a predetermined schedule.

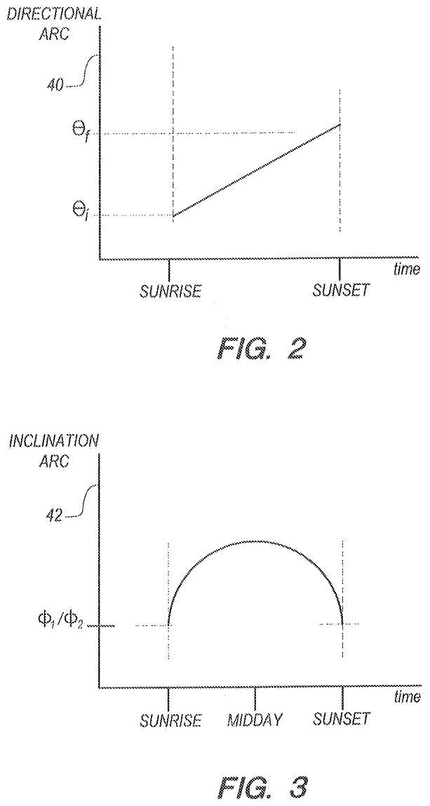

In detail, the extension arm 26 is rotated in a horizontal plane through a directional angle θ that is measured in a directional arc 40. More specifically, as seen in FIG. 1 and graphically presented in FIG. 2, the directional arc 40 extends between an initial angle θᵢ and a final angle θ_{f} (i.e. θᵢ:θ_{f}). In accordance with the predetermined schedule mentioned above, the initial direction angle θᵢ is established daily relative to sunrise on the day of operation, and the directional angle θ steadily increases during the day until the final directional angle θ_{f} is established relative to sunset on the same day of operation. As will be appreciated by the skilled artisan the directional arc will be traversed each day, and the length of the directional arc 40 (i.e. θᵢ:θ_{f}) will change from day to day.

As part of the predetermined schedule, the motor also rotates the solar panel 12. Specifically, for this rotation as shown in FIG. 1 and graphically presented in FIG. 3, the inclination angle Φ extends between an angle Φ₁ and an angle Φ₂ through an inclination arc 42 (i.e. Φ₁, Φ₂), Unlike the directional angle θ, however, the inclination angle Φ is measured in a vertical plane. Further, for the inclination arc 42, Φ₁ is established daily relative to both sunrise and sunset on the day of operation. On the other hand, Φ₂ is established relative to midday on the day of operation. Together, the directional arc 40 and the inclination arc 42 are established relative to the latitude of the apparatus 10. With the above in mind, it is to be remembered that the angle Ψ for rotation of the wind turbine 14 around the vertical axis 32 will extend through a 360° arc and is time independent.

For support and stability considerations concerning the present invention, the solar panel 12 will have a weight Wₛ and the wind turbine 14 will have a weight W_{w}. Also, the extension arm 26 will have a balance point 36 between its end points. Importantly, the balance point 36 will be located on the support pole 22 with the weight W_{w} of the wind turbine 14 acting on the extension arm 26 at a distance d_{w} from the balance point 36. Also, the weight Wₛ of the solar panel 12 will be acting on the extension arm 26 at a distance dₛ from the balance point 36. In this combination W_{w} and Wₛ are to be counterbalanced (i.e. W_{w}d_{w}=Wₛdₛ).

The consequences of selecting appropriate dimensions for the above combination of structure include the fact that the wind turbine 14 will always be located dower-sun from the solar panel 12. Also, the wind turbine 14 will be positioned on the extension arm 26 and located at a vertical height h_{w} above the extension arm 26 to avoid an interference in wind flow through the wind turbine 14 that might otherwise be caused by turbulent airflow caused by the solar panel 12.

For an optional embodiment of the present invention the wind/solar electric generator can be somehow connected with a public grid. In particular, it is envisioned that a connection can be made directly with an existing public utility, such as a light post (not shown), or a commercially available grid outlet.

In any event, electricity taken from a public grid will be prioritized with energy from the wind/solar electric generator so that energy collected from the wind/solar electric generator is used first, Also, excess energy can be returned to the grid for the purpose of generating revenue.

While the particular Light Tracking Assembly for Solar and Wind Power Energy as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. An apparatus for collecting and storing renewable energy which comprises:
a support pole defining a pole axis;
an extension arm mounted on the support pole wherein the extension arm has a first end and a second end;
a solar panel mounted on the extension arm at the first end thereof for collecting solar energy, wherein the solar panel defines a panel axis inclined at an angle Φ relative to the pole axis;
a wind turbine mounted on the extension arm at the second end thereof for collecting wind energy, wherein the wind turbine is free to rotate through an angle Ψ about an axis parallel to the pole axis; and
a storage battery connected to the solar panel arid to the wind turbine to store the collected energy.

2. The apparatus of claim 1 wherein the extension arm is mounted for rotation on the support pole around the pole axis in a plane perpendicular to the pole axis, and the solar panel is mounted on the extension arm for rotation around an axis perpendicular to the extension arm and perpendicular to the pole axis, and further wherein the apparatus comprises a motor mounted on the apparatus and programmed for rotating the extension arm through a predetermined angle θ and for rotating the solar panel through a predetermined angle D in accordance with a predetermined schedule.

3. The apparatus of claim 2 wherein the angle θ is in a directional arc extending between an initial angle θᵢ and a final angle θ_{f}, wherein the angle Φ is in an inclination arc extending between an angle Φ₁ and Φ₂, and wherein the directional arc θᵢ:θ_{f} and the inclination arc Φ₁:Φ₂ are established daily in accordance with the predetermined schedule.

4. The apparatus of claim 3 wherein θᵢ is established relative to sunrise on the day of operation, and θ_{f} is established relative to sunset on the day of operation, and further wherein Φ₁ is established relative to sunrise and sunset on the day of operation and Φ₂ is established relative to midday on the day of operation, and further wherein the directional arc and the inclination arc are established relative to the latitude of the apparatus.

5. The apparatus of claim 1 wherein the solar panel has a weight Wₛ and the wind turbine has a weight W_{w}, and wherein the extension arm has a balance point between its first and second ends, and further wherein the balance point is located on the support pole with the weight of the wind turbine W_{w} acting on the extension arm at a distance d_{w} from the balance point and with the weight of the solar panel Wₛ acting on the extension arm at a distance d from the balance point to counterbalance W_{w} with Wₛ (W_{w}d_{w}=Wₛdₛ).

6. The apparatus of claim 5 wherein the wind turbine is located at a vertical height h_{w} above the extension arm.

7. The apparatus of claim 5 wherein the wind turbine is positioned on the apparatus down-sun from the solar panel and is positioned to avoid an interference in wind flow caused by the solar panel.

8. The apparatus of claim 1 wherein the apparatus is connected to a public grid for collecting electricity from the grid.

9. The apparatus of claim 1 wherein a plurality of photovoltaic cells is mounted in an array on the solar panel.

10. An apparatus for collecting and storing renewable energy which comprises:
a support pole defining a pole axis;
an extension arm mounted for rotation on the support pole around the pole axis in a plane perpendicular to the pole axis, wherein the extension arm has a first end and a second end;
a means for collecting solar energy mounted on the extension arm for rotation therewith;
a means for collecting wind energy mounted on the extension arm for rotation therewith; and
a storage battery connected to the solar panel and to the wind turbine to store the collected energy.

11. The apparatus of claim 10 wherein the means for collecting solar energy is a solar panel mounted on the extension arm at the first end thereof, and wherein the solar panel is inclined at a predetermined angle Φ relative to the pole axis, and wherein the means for collecting wind energy is a wind turbine mounted on the extension arm at the second end thereof, wherein the wind turbine is free to rotate through an angle Ψ about an axis parallel to the pole axis.

12. The apparatus of claim 11 wherein the solar panel is mounted on the extension arm for rotation around an axis perpendicular to the extension arm and perpendicular to the pole axis, and further wherein the apparatus comprises a motor mounted on the apparatus for rotating the extension arm through a predetermined angle θ and for rotating the solar panel through a predetermined angle Φ in accordance with a predetermined schedule.

13. The apparatus of claim 12 wherein the angle θ is in a directional arc extending between an initial angle θᵢ and a final angle θ_{f}, wherein the angle Φ is in an inclination arc extending between an angle Φ₁ and Φ₂, and wherein the directional arc θᵢ:θ_{f} and the inclination arc Φ₁:Φ₂ are established daily in accordance with the predetermined schedule.

14. The apparatus of claim 13 wherein θᵢ is established relative to sunrise on the day of operation, and θ_{f} is established relative to sunset on the day of operation, and further wherein Φ₁ is established relative to sunrise and sunset on the day of operation and Φ₂ is established relative to midday on the day of operation, and further wherein the directional arc and the inclination arc are established relative to the latitude of the apparatus.

15. The apparatus of claim 10 wherein the means for collecting solar energy is a solar panel having a weight Wₛ and the means for collecting wind energy is a wind turbine having a weight W_{w}, and wherein the extension arm has a balance point between its first and second ends, and further wherein the balance point is located on the support pole with the weight of the wind turbine W_{w} acting on the extension arm at a distance d_{w} from the balance point and with the weight of the solar panel Wₛ acting on the extension arm at a distance dₛ from the balance point to counterbalance W_{w} with Wₛ (W_{w}d_{w}=Wₛdₛ).

16. The apparatus of claim 15 wherein the wind turbine is positioned on the apparatus down-sun from the solar panel, and is positioned on the apparatus to avoid an interference in wind flow caused by the solar panel.

17. A method for collecting and storing renewable energy which comprises the steps of:
providing an apparatus including a support pole defining a pole axis, an extension arm mounted on the support pole wherein the extension arm has a first end and a second end, with a solar panel mounted on the extension arm at the first end of the extension arm for collecting solar energy, wherein the solar panel defines a panel axis inclined at an angle Φ relative to the pole axis, and with a wind turbine mounted at the second end of the extension arm for collecting wind energy, wherein the wind turbine is free to rotate through an angle Ψ about an axis parallel to the pole axis, and with a storage battery connected to the solar panel and to the wind turbine to store the collected energy; and
rotating the extension arm on the support pole around the pole axis in a plane perpendicular to the pole axis through a predetermined angle θ, while rotating the solar panel around an axis perpendicular to the extension arm and perpendicular to the pole axis through a predetermined angle Φ in accordance with a predetermined schedule.

18. The method of claim 17 wherein the angle θ is in a directional arc extending between an initial angle θᵢ and a final angle θ_{f}, and the angle Φ is in an inclination arc extending between an angle Φ₁ and Φ₂.

19. The method of claim 18 wherein the predetermined schedule is established daily with θᵢ being established relative to sunrise on the day of operation, and θ_{f} being established relative to sunset on the day of operation, and further wherein Φ₁ is established relative to sunrise and sunset on the day of operation, and Φ₂ is established relative to midday on the day of operation, and further wherein the directional arc and the inclination arc are established relative to the latitude of the apparatus.

20. The method of claim 19 wherein the wind turbine is positioned on the apparatus down-sun from the solar panel and further wherein the wind turbine is positioned on the apparatus to avoid an interference in wind flow caused by the solar panel.
